(19) United States
(12) Patent Application Publication
(10) Pub. No.: US 2026/0188773 A1
(43) Pub. Date: Jul. 2, 2026

(54) LITHIUM RECOVERY METHOD

(71) Applicant: HONDA MOTOR CO., LTD., Tokyo (JP)

(72) Inventors: Mitsumasa Sorazawa, Wako-shi (JP); Takayuki Sakata, Wako-shi (JP); Yushi Fujinaga, Wako-shi (JP); Satoru Takahashi, Wako-shi (JP)

(21) Appl. No.: 19/430,734

(22) Filed: Dec. 23, 2025

(30) Foreign Application Priority Data
Dec. 27, 2024 (JP) 2024-232127

(51) Int. Cl. H01M 10/54; C22B 3/22; C22B 7/00; C22B 26/12; H01M 10/0525

(52) U.S. Cl. CPC H01M 10/54; C22B 3/22; C22B 7/006; C22B 26/12; H01M 10/0525

(57) ABSTRACT

A lithium recovery method from a used lithium-ion secondary battery including an electrode assembly having a positive electrode, a sulfide solid electrolyte, and a negative electrode, the method including: dissolving a solid electrolyte and a lithium compound contained in a deactivated lithium-ion secondary battery in pure water to obtain a dispersion liquid; recovering a separation solution by performing solid-liquid separation on the dispersion liquid; performing oxidation treatment on the separation solution to generate an acidic component in the separation solution and adjusting a pH of the separation solution; aerating the separation solution after the oxidation treatment with air or an oxidizing gas and adjusting the pH of the separation solution; recovering a recovery stock solution by performing solid-liquid separation on the separation solution after the aeration treatment; and extracting a lithium hydroxide aqueous solution from the recovery stock solution through electrodialysis using a cation exchange membrane.

### CROSS-REFERENCE TO RELATED APPLICATION

Priority is claimed on Japanese Patent Application No. 2024-232127, filed Dec. 27, 2024, the content of which is incorporated herein by reference.

### BACKGROUND

### Field of the Invention

The present invention relates to a lithium recovery method.

### Description of Related Art

In recent years, research and development has been conducted on so-called all-solid-state batteries, which use solid electrolytes instead of liquid electrolytes. Since all-solid-state batteries do not use organic solvents, they are expected to offer improved safety and the like. In addition, as with traditional batteries, developments of recycling technologies are also in progress for all-solid-state batteries from the perspective of efficient resource utilization (see, for example, Japanese Unexamined Patent Application, First Publication No. 2024-98840).

### SUMMARY

As described in Japanese Unexamined Patent Application, First Publication No. 2024-98840, for recycling an all-solid-state battery, treatment is performed by deactivating and then immersing the battery in water, and a solid electrolyte and lithium are dissolved and separated from solid components such as a positive electrode active material. Then, lithium is recovered from the separation solution in which lithium is dissolved. As one of methods for recovering lithium from a separation solution, electrodialysis can be exemplified. The separation solution contains ions of sulfur and phosphorus, which are components of the solid electrolyte. These ions react with dissolved oxygen in the alkaline pH range, producing S₂O₃²⁻ (thiosulfate ions) and PO₄³⁻ (phosphate ions). During electrodialysis, S₂O₃²⁻ (thiosulfate ions) undergo an oxidation reaction, producing SO₄²⁻ (sulfate ions) and sulfur microparticles, which leads to deterioration of solution circulation and degradation of a membrane used in the electrodialysis. PO₄³⁻ (phosphate ions) bind with lithium to form Li₃PO₄ (lithium phosphate) when they reach saturation concentration, which impairs solution circulation and reduces a lithium recovery rate.

S₂O₃²⁻ (thiosulfate ions) undergo an oxidation reaction during the electrodialysis, producing sulfur microparticles, and thus need to be removed before the electrodialysis. S₂O₃²⁻ (thiosulfate ions) contained in the separation solution are oxidized to generate SO₄²⁻ (sulfate ions) and sulfur microparticles before the electrodialysis, and the sulfur microparticles are removed by filtration or other methods.

Li₃PO₄ (lithium phosphate), which is generated from the PO₄³⁻ (phosphate ions), dissolves in strong acids with a pH of 2 or lower, and thus, by acidifying the separation solution, which is highly alkaline, through oxidation of the contained ions, lithium can be redissolved to prevent a decrease in the recovery rate.

As a method for promoting oxidation of the separation solution, forced oxidation performed by aerating ozone through the separation solution is preferable. By adjusting a pH of the separation solution to around 2, 90% or more of sulfur components contained in the separation solution are oxidized, and thus the generation of sulfur microparticles can be inhibited during lithium recovery, and by redissolving Li₃PO₄ (lithium phosphate), the lithium recovery rate can be recovered.

Aspects of the present application provide a lithium recovery method that can inhibit hindrance to recovery due to sulfur microparticles, hindrance to lithium recovery due to precipitation of lithium phosphate, and a decrease in lithium recovery rate. In addition, aspects of the present application contribute to a significant reduction in waste generation.

Aspects of the present invention provide the following configurations.
[1] A lithium recovery method from a used lithium-ion secondary battery including an electrode assembly having a positive electrode, a sulfide solid electrolyte, and a negative electrode, the method including: dissolving a solid electrolyte and a lithium compound contained in a deactivated lithium-ion secondary battery in pure water to obtain a dispersion liquid; recovering a separation solution by performing solid-liquid separation of the dispersion liquid; performing oxidation treatment on the separation solution to generate an acidic component in the separation solution and adjusting a pH of the separation solution; aerating the separation solution after the oxidation treatment with air or an oxidizing gas and adjusting the pH of the separation solution; recovering a recovery stock solution by performing solid-liquid separation of the separation solution after the aeration treatment; and extracting a lithium hydroxide aqueous solution from the recovery stock solution through electrodialysis using a cation exchange membrane.
[2] The lithium recovery method according to [1], wherein the pH of the separation solution is adjusted to 7 to 12 in the oxidation treatment, and the pH of the separation solution is adjusted to 2 or less in the aerating.
[3] The lithium recovery method according to [1] or [2], further including removing impurity anions from the lithium hydroxide aqueous solution using an anion exchange resin.

According to the aspects of the present invention, a lithium recovery method that can inhibit hindrance to recovery due to generation of sulfur microparticles, hindrance to lithium recovery due to precipitation of lithium phosphate, and a decrease in lithium recovery rate can be provided.

### BRIEF DESCRIPTION OF THE DRAWINGS

FIG. 1 is a flowchart of a lithium recovery method according to one embodiment of the present invention.

FIG. 2 is a cross-sectional view schematically showing a lithium recovery device according to one embodiment of the present invention.

### DETAILED DESCRIPTION OF THE INVENTION

An embodiment of the present invention will be described in detail below, but the following description is merely an example of the embodiment of the present invention, and the present invention is not limited to these details and can be modified and implemented within the scope of the present invention.

### Lithium Recovery Method

A lithium recovery method according to one embodiment of the present invention is a method for recovering lithium from a used lithium-ion secondary battery including an electrode assembly having a positive electrode, a sulfide solid electrolyte, and a negative electrode.

The lithium recovery method according to one embodiment of the present invention includes a dissolution process of dissolving the solid electrolyte and a lithium compound contained in a deactivated lithium-ion secondary battery in pure water to obtain a dispersion liquid, a separation solution recovery process of performing solid-liquid separation on the dispersion liquid to recover a separation solution, an oxidation process of performing oxidation treatment on the separation solution to generate an acidic component in the separation solution and adjusting a pH of the separation solution, an aeration process of aerating the separation solution after the oxidation treatment with air or an oxidizing gas and adjusting the pH of the separation solution, a recovery stock solution recovery process of recovering a recovery stock solution by performing solid-liquid separation on the separation solution after the aeration treatment, and a process of extracting a lithium hydroxide aqueous solution from the recovery stock solution through electrodialysis using a cation exchange membrane.

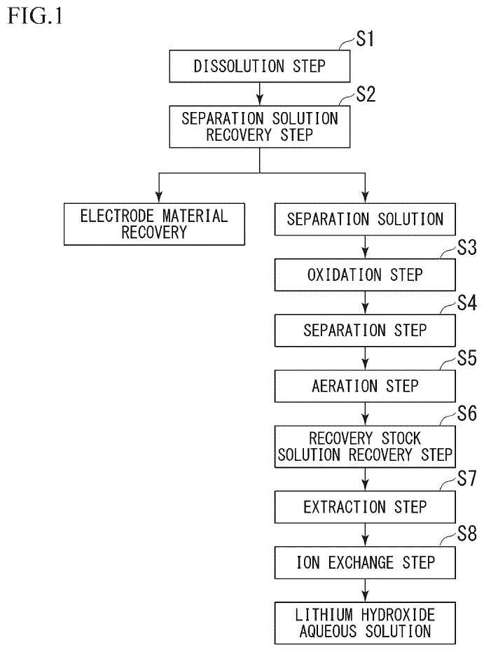

FIG. 1 is a flowchart of the lithium recovery method of the present embodiment.

### Dissolution Process

In the dissolution step S1, after the used lithium-ion secondary battery is deactivated, treatment target members of the deactivated lithium-ion secondary battery are stirred in the pure water, and the solid electrolyte and the lithium compound included in the treatment target members are dissolved in the pure water to prepare the dispersion liquid. Note that the treatment target members are members constituting the deactivated lithium-ion secondary battery.

Deactivation treatment of the used lithium-ion secondary batteries can be performed using a known method (see, for example, Japanese Unexamined Patent Application, First Publication No. 2023-124857, International Publication No. WO 2021/201151, or the like).

The treatment target members include a positive electrode active material, positive electrode materials other than the positive electrode active material (a conductive additive, a binder, and the like), copper from a negative electrode current collector, sulfur and phosphorus derived from an electrolyte, current collector tabs, and current collectors. For example, a positive electrode including a current collector and a positive electrode active material layer formed on the current collector is crushed and dispersed in fragments of a desired size, a filtrate, a separation solution after the extraction, or a mixture of these to prepare a dispersion liquid. The obtained dispersion liquid contains, as solid components, the positive electrode active material, positive electrode materials other than the positive electrode active material, a current collector tab, the current collector, and the like.

The positive electrode active material is not particularly limited and may be any material known as a positive electrode active material for lithium-ion secondary batteries. Examples of the positive electrode active material include ternary positive electrode materials such as LiCoO₂, LiNiO₂, and NCM (Li(NiₓCo_{y}Mn_{z})O₂, (0<x<1, 0<y<1, 0<z<1, and x+y+z=1)), layered positive electrode active material particles such as LiVO₂ and LiCrO₂, spinel-type positive electrode active materials such as LiMn₂O₄, Li(Ni_{0.25}Mn_{0.75})₂O₄, LiCoMnO₄, and Li₂NiMn₃O₈, olivine-type positive electrode active materials such as LiCoPO₄, LiMnPO₄, and LiFePO₄, and the like.

Pure water is used in the dissolution step S1 because natural water, tap water, and other sources contain, as minerals, alkali metals and alkaline earth metals such as sodium, potassium, calcium, and magnesium, which impair separation properties of the cation exchange membrane. Alkali metals and alkaline earth metals contaminate the recovered lithium.

In the dissolution step S1, since the dispersion liquid contains the solid electrolyte containing lithium, a pH of the dispersion liquid is 11 or more and 14 or less. To achieve a lithium recovery rate of 80% or higher, the dispersion liquid is required to contain at least 0.4 mol/L, preferably at least 0.7 mol/L of lithium dissolved therein.

### Separation Solution Recovery Process

In the separation solution recovery step S2, the solid components contained in the dispersion liquid, such as the positive electrode active material, the positive electrode materials other than the positive electrode active material, the current collector tabs, and the current collectors, are filtered, separated, and removed to recover the separation solution. In this step, water-insoluble solid components of the lithium-ion secondary battery are removed. Examples of the water-insoluble solid components include positive electrode active materials, binders, conductive additives, tabs, electrodes, and the like.

The separation solution obtained in the separation solution recovery step S2 contains, for example, chlorine (Cl), bromine (Br), phosphorus (P), sulfur(S), aluminum (Al), nickel (Ni), copper (Cu), and the like.

### Oxidation Process

In the oxidation step S3, the separation solution is oxidized to generate the acidic component in the separation solution, thereby adjusting the pH of the separation solution. The pH of the separation solution is preferably 7 or more and 12 or less. The pH value is adjusted by leaving the separation solution in air, aerating (bubbling) the separation solution with air, aerating (bubbling) the separation solution with an oxidizing gas such as ozone, oxygen gas, or active oxygen gas, or by heating the separation solution. These treatments promote the reaction in which phosphorus (P) in the separation solution becomes PO₄ and the reaction in which sulfur(S) in the separation solution becomes S₂O₃ or SO₄, thereby adjusting the pH of the separation solution. Examples of the active oxygen gas include superoxides, hydroxyl radicals, and the like.

In the treatment of leaving the separation solution in air, for example, the separation solution is left to stand for 10 hours to 100 days.

In the treatment of aerating the separation solution with air, for example, the separation solution is aerated with air for 4 hours to 10 days.

In the treatment of aerating the separation solution with an oxidizing gas, for example, ozone is aerated into the separation solution for 2 hours to 5 hours.

In the treatment of heating the separation solution, for example, the separation solution is heated to a temperature of 40° C. or more to 90° C. or less.

This precipitates hydroxides of copper, nickel, aluminum, and the like.

The pH of the separation solution is adjusted through the oxidation treatment by utilizing the fact that saturation solubilities of copper and nickel in the separation solution decrease to 10 mg/L in the pH range of 7 to 12, and thus the precipitation of hydroxides of copper, nickel, aluminum, and the like is promoted. The pH of the dispersion liquid immediately after the solid electrolyte has been dissolved reaches around 12, which is due to the dissolution of lithium ions in the lithium-ion secondary battery. Further, due to a sulfide reaction caused by a hydrogen sulfide gas generated when the solid electrolyte is dissolved in water, the content of contaminants such as copper, nickel, and aluminum in the separation solution can reach several hundred mg/L. For that reason, to stabilize an ionic state in the separation solution, the pH of the separation solution is desirably lowered to 10 or less. If the pH of the separation solution falls below 7, dissolved concentrations of copper and nickel will increase because they are soluble in acid.

The pH of the separation solution can be adjusted using an acidic liquid (such as sulfuric acid or hydrochloric acid), but this is burdensome because it involves the release of hydrogen sulfide, which is a harmful, flammable, and corrosive gas. Since large amounts of phosphorus and sulfur are eluted in the separation solution, it is desirable to oxidize these in the separation solution to bring the pH of the separation solution into a neutral range. For this reason, in the lithium recovery method of the present embodiment, the pH of the separation solution is adjusted without using an acidic liquid by leaving the separation solution in air, aerating (bubbling) the separation solution with air, aerating (bubbling) the separation solution with an oxidizing gas such as ozone, or heating the separation solution.

### Separation Process

The lithium recovery method of the present embodiment may include a separation step S4. In the separation step S4, solid components (such as aluminum-containing compounds, nickel-containing compounds, and copper-containing compounds) are filtered, separated, and removed from the separation solution that has gone through the oxidation step S3.

### Aeration Process

In the aeration step S5, the separation solution obtained in the oxidation step S3 is aerated with air or the oxidizing gas. This further adjusts the pH of the separation solution. The pH of the separation solution is preferably 2 or less. The pH value is adjusted by aerating (bubbling) the separation solution with air, or by aerating (bubbling) the separation solution with the oxidizing gas such as ozone, oxygen gas, or active oxygen gas. Through these treatments, by sulfating HS⁻ (hydrogen sulfide ions) and S₂O₃ ²⁻ (thiosulfate ions) contained in the separation solution to oxidize the separation solution strongly (pH 2 or less), the acid-soluble Li₃PO₄ (lithium phosphate) can be redissolved, thereby inhibiting hindrance to lithium recovery due to the precipitation of lithium phosphate, and a decrease in lithium recovery rate.

### Recovery Stock Solution Recovery Process

In the recovery stock solution recovery step S6, solid-liquid separation is performed on the separation solution after the oxidation treatment to recover the recovery stock solution. In the recovery stock solution recovery step S6, solid components (sulfur microparticles) are filtered, separated, and removed from the separation solution that has gone through the aeration step S5.

### Extraction Process

In the extraction step S7, the lithium hydroxide aqueous solution is extracted from the recovery stock solution through the electrodialysis using the cation exchange membrane.

In the extraction step S7, examples of a material for the cation exchange membrane include sodium sulfonate and polyolefin. The lithium hydroxide aqueous solution reaches a pH of 12 or higher as concentration of lithium progresses, while the recovery stock solution serving as a recovery source undergoes strong oxidation to a pH of around 1 as reduction of lithium and oxidation of anionic components progresses, and thus the cation exchange membrane requires a wide pH resistance range.

According to the electrodialysis using the cation exchange membrane, lithium ions contained in the recovery stock solution permeate the cation exchange membrane, and on the permeated side, the lithium ions react with water to form lithium hydroxide. That is, the lithium hydroxide aqueous solution is produced on the permeated side of the cation exchange membrane. As an electrodialysis method, for example, a method of setting constant current processing at 0.3 A and stopping the process when a voltage across electrodes reaches a membrane's withstand voltage limit, which is a trigger can be exemplified. Also, as an electrodialysis method, for example, a method of setting a voltage to be equal to or lower than a membrane's withstand voltage or less for constant voltage processing and stopping the process when a current value becomes a certain value or less can be exemplified.

In the extraction step S7, copper (Cu), nickel (Ni), aluminum (Al), phosphate ions (PO₄³⁻), and the like do not permeate the cation exchange membrane if their concentrations in the recovery stock solution are less than several tens of ppm or less. Chlorine (Cl), bromine (Br), sulfate ions (SO₄²⁻), and the like hardly permeate the cation exchange membrane. For that reason, in the extraction step S7, these substances are separated from lithium.

### Ion Exchange Process

The lithium recovery method of the present embodiment may also include an ion exchange step S8. In the ion exchange step S8, the lithium hydroxide aqueous solution obtained in the extraction step S7 is brought into contact with an anion exchange resin to remove trace amounts (on the order of ppm) of impurity anions such as chlorine (Cl), bromine (Br), and sulfate ions (SO₄²⁻) contained in the lithium hydroxide aqueous solution.

In the ion exchange step S8, the temperature at which the lithium hydroxide aqueous solution is brought into contact with the anion exchange resin is preferably 10° C. or higher and 40° C. or lower.

Through the above steps, a high-purity lithium hydroxide aqueous solution can be obtained.

According to the lithium recovery method of the present embodiment, by inhibiting hindrance to recovery due to the generation of sulfur microparticles, hindrance to lithium recovery due to the precipitation of lithium phosphate, and a decrease in lithium recovery rate, lithium can be recovered solely from the solid electrolyte aqueous solution through the electrodialysis using the cation exchange membrane.

### Lithium Recovery Device

A lithium recovery device according to one embodiment of the present invention is a device that recovers lithium from a used lithium-ion secondary battery.

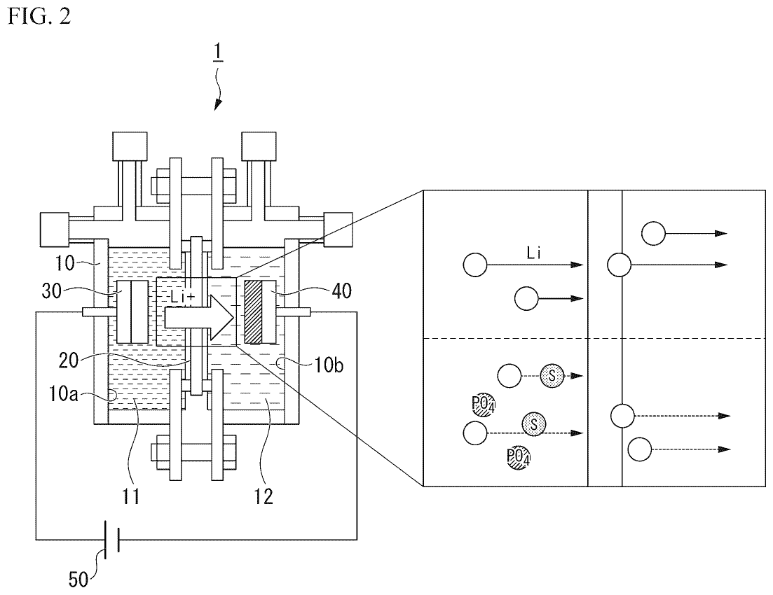

FIG. 2 is a cross-sectional view schematically showing the lithium recovery device of the present embodiment.

A lithium recovery device 1 includes a treatment tank 10, a cation exchange membrane 20, a first electrode 30, a second electrode 40, and a power supply 50.

The treatment tank 10 has a first space 11 and a second space 12, which are separated by the cation exchange membrane 20 provided in the treatment tank 10. An inner surface thereof in the first space 11, which faces the cation exchange membrane 20 at a distance, is one main surface 10a of the treatment tank 10. An inner surface thereof in the second space 12, which faces the cation exchange membrane 20 at a distance, is the other main surface 10b of the treatment tank 10.

The treatment tank 10 is a tank for treating the dispersion liquid obtained by dispersing a water-soluble solid electrolyte contained in the treatment target material of the deactivated lithium-ion secondary battery in pure water through electrodialysis.

The cation exchange membrane 20 is disposed in a central portion of the treatment tank 10 in a height direction of the treatment tank 10 to separate the first space 11 and the second space 12 of the treatment tank 10 from each other.

As the cation exchange membrane 20, the same type as that used in the lithium recovery method of the above-described embodiment can be used.

The first electrode 30 is disposed on the one main surface 10a side of the treatment tank 10 in the first space 11.

The second electrode 40 is disposed on the other main surface 10b side of the treatment tank 10 in the second space 12.

The power supply 50 is connected to the first electrode 30 and the second electrode 40. The power supply 50 applies a voltage required for the electrodialysis to the first electrode 30 and the second electrode 40.

A lithium recovery method using the lithium recovery device 1 of the present embodiment will be described.

A separation solution that has gone through the dissolution step S1, the separation solution recovery step S2, the oxidation step S3, the aeration step S5, and the recovery stock solution recovery step S7 of the lithium recovery method in the above-described embodiment is prepared.

In the lithium recovery device 1 of the present embodiment, the extraction step S7 of the lithium recovery method in the above-described embodiment is performed.

The separation solution is injected into the first space 11 of the treatment tank 10, and a dilute lithium hydroxide aqueous solution is injected into the second space 12 of the treatment tank 10 as a recovery solution to ensure conductivity.

In this state, when a voltage is applied to the first electrode 30 and the second electrode 40 from the power supply 50, electrodialysis begins, and lithium ions contained in the separation solution in the first space 11 permeate the cation exchange membrane and move to the recovery liquid in the second space 12. The lithium ions that have permeated the cation exchange membrane react with water in the second space 12 to form lithium hydroxide. That is, a lithium hydroxide aqueous solution is produced in the second space 12. Also, since trace amounts (on the order of ppm) of chlorine (Cl), bromine (Br), and sulfate ions (SO₄²⁻) permeate the cation exchange membrane, the lithium hydroxide aqueous solution contains the trace amounts (on the order of ppm) of chlorine (Cl), bromine (Br), and sulfate ions (SO₄²⁻).

According to the lithium recovery device of the present embodiment, lithium can be recovered solely from the solid electrolyte aqueous solution through the electrodialysis using the cation exchange membrane without adding a preparation to adjust the pH.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

Aspects of the present invention provide the following configurations.
[1] A lithium recovery method from a used lithium-ion secondary battery including an electrode assembly having a positive electrode, a sulfide solid electrolyte, and a negative electrode, the method including: dissolving a solid electrolyte and a lithium compound contained in a deactivated lithium-ion secondary battery in pure water to obtain a dispersion liquid; recovering a separation solution by performing solid-liquid separation of the dispersion liquid; performing oxidation treatment on the separation solution to generate an acidic component in the separation solution and adjusting a pH of the separation solution; aerating the separation solution after the oxidation treatment with air or an oxidizing gas and adjusting the pH of the separation solution; recovering a recovery stock solution by performing solid-liquid separation of the separation solution after the aeration treatment; and extracting a lithium hydroxide aqueous solution from the recovery stock solution through electrodialysis using a cation exchange membrane.

According to the above aspect, by performing oxidation treatment on the separation solution to generate the acidic component in the separation solution and adjusting the pH of the separation solution, and then aerating the separation solution with air or the oxidizing gas, hindrance to recovery due to the generation of sulfur microparticles can be inhibited, and by redissolving the acid-soluble Li₃PO₄ (lithium phosphate), hindrance to lithium recovery due to the precipitation of lithium phosphate and a decrease in lithium recovery rate can be inhibited.
[2] The lithium recovery method according to [1], wherein the pH of the separation solution is adjusted to 7 to 12 in the oxidation treatment, and the pH of the separation solution is adjusted to 2 or less in the aerating.

According to the above aspect, by adjusting the pH of the separation solution through the oxidation treatment by utilizing the fact that saturation solubilities of copper and nickel in the separation solution decrease to 10 mg/L in the pH range of 7 to 12, the precipitation of hydroxides of copper, nickel, aluminum, and the like can be promoted. Further, by sulfating HS⁻ (hydrogen sulfide ions) and S₂O₃²⁻ (thiosulfate ions) contained in the separation solution through the oxidation treatment, the sulfur microparticles can be precipitated before the electrodialysis and then removed by filtration, thereby inhibiting hindrance to recovery, and by strongly oxidizing the separation solution (pH 2 to 5), the acid-soluble Li₃PO₄ (lithium phosphate) can be redissolved, thereby inhibiting hindrance to lithium recovery due to the precipitation of lithium phosphate and a decrease in lithium recovery rate.
[3] The lithium recovery method according to [1] or [2], further including removing impurity anions from the lithium hydroxide aqueous solution using an anion exchange resin.

According to the above aspect, by bringing the lithium hydroxide aqueous solution into contact with the anion exchange resin, trace amounts (on the order of ppm) of chlorine (Cl), bromine (Br), sulfate ions (SO₄²⁻), and the like contained in the lithium hydroxide aqueous solution can be removed.

What is claimed is:

1. A lithium recovery method from a used lithium-ion secondary battery including an electrode assembly having a positive electrode, a sulfide solid electrolyte, and a negative electrode, the method comprising:
dissolving a solid electrolyte and a lithium compound contained in a deactivated lithium-ion secondary battery in pure water to obtain a dispersion liquid;
recovering a separation solution by performing solid-liquid separation on the dispersion liquid;
performing oxidation treatment on the separation solution to generate an acidic component in the separation solution and adjusting a pH of the separation solution;
aerating the separation solution after the oxidation treatment with air or an oxidizing gas and adjusting the pH of the separation solution;
recovering a recovery stock solution by performing solid-liquid separation on the separation solution after the aeration treatment; and
extracting a lithium hydroxide aqueous solution from the recovery stock solution through electrodialysis using a cation exchange membrane.

2. The lithium recovery method according to claim 1, wherein the pH of the separation solution is adjusted to 7 to 12 in the oxidation treatment, and the pH of the separation solution is adjusted to 2 or less in the aerating.

3. The lithium recovery method according to claim 1, further comprising removing impurity anions from the lithium hydroxide aqueous solution using an anion exchange resin.
